(19) United States
(12) Patent Application Publication
(10) Pub. No.: US 2003/0010173 A1
(43) Pub. Date: Jan. 16, 2003

(54) Precision laser cutting guide

(76) Inventor: James Alan Hayden, Rock Hill, MO (US)

Correspondence Address: Randal D. Homburg, P.O. Box 10470, Midwest City, OK, 73140-1470, US

(21) Appl. No.: 09/904,133

(22) Filed: Jul. 13, 2001

(51) Int. Cl. B26D 7/00; B27B 5/20; B27B 9/00

(52) U.S. Cl. 83/520; 83/521; 83/522.17; 30/388

(57) ABSTRACT

The invention is an attachment for a stationary power saw, attaching to an operationally non-moving base or frame member of the power saw, as opposed to the retractable saw blade portion of the power saw, providing a fully adjustable laser cutting guide for designating the strike point of the rotating saw blade on the material being cut by the saw blade.

### CROSS REFERENCE TO RELATED APPLICATIONS

Provisional Patent Application, Atty. Doc. No. 2001—Hayden, James A., filed on May 30, 2001. (No Serial No. as of the date of the filing of this Non-provisional Utility Patent Application).

### I. BACKGROUND OF INVENTION

1. Field of the Invention

The invention is an attachment for a stationary power saw, attaching to an operationally non-moving base or frame member of the power saw, as opposed to the retractable saw blade portion of the power saw, providing a fully adjustable laser cutting guide for designating the strike point of the rotating saw blade on the material being cut by the saw blade.

2. Description of Prior Art

The following United States patents are identified and disclosed herein. Several devices are disclosed relating to lighted cutting guides. Those patents are distinguishable from the current invention, in accordance with 35 U.S.C. §§102 and 103. In U.S. Pat. No. 5,996,460 to Waite, a kerf indicator for a power saw, shown primarily as a pivoting miter saw, light is directed towards the blade of the saw, such device mounting to the movable portion of the saw. This light shadows the saw blade, with the shadow actually indicative of the strike point of the saw blade. This invention claims the entire power saw, and includes a light source positioned within the saw housing in alignment with the plane of the blade to produce a shadow on the workpiece, and an opaque barrier that allows for adjustable polarization of the light adjusting the width of the shadow cast on the workpiece between 0.07 and 0.01 inches. The current invention attaches to an immovable portion of the stationary saw and has a light indicative of the blade strike point on the workpiece.

In U.S. Pat. No. 5,862,727 to Kelly, a retrofitted laser arbor is provided which attaches to the fitting to which the saw blade is attached, activated by a centrifugal switch which causes the laser indicator to illuminate only when the saw blade is rotating. U.S. Pat. No. 5,375,495 to Bosten, et al., discloses an optical alignment system for nearly stationary and hand-held rotary power saws. This device attaches to the front portion of the upper guard of a circular saw and indicates the left or right side of the cutting blade using an adjustment means. It does not indicate the entire striking location for the entire saw blade. Another embodiment of the invention allows for both sides of the blade to be indicated by arrows employing mirrors for provision of the optical off-setting mechanism. In the claims, the light source is attached to the housing of the power saw or is located proximately to the cutting means forming a linear optical alignment marker on one side of the blade, a lateral adjustment means for lateral movement of the optical alignment marker, and a means for rotation of the optical marker on the workpiece to adjust the parallelism of the optical alignment marker with respect to one side of the blade (claims 1-19).

U.S. Pat. No. 5,285,708 to Bosten, et al., is nearly identical to the previously disclosed patent, except its limitation is attachment to the cutting means of a miter saw. It is not attached to the turntable or the base of the miter saw, these saw features identified in the utility patent and distinguished from the cutting portion to which the light projecting means is attached. In U.S. Pat. No. 5,675,899 to Webb, a rotatable end piece is located in the housing of the circular saw through which a laser beam is projected on a workpiece indicative of a cutting guide for the saw which is pushed along a cutting line in front of the saw.

U.S. Pat. No. 4,885,967 to Bell, et al., discloses a laser alignment guide for sawmills. This device has multiple laser indicator indicative of the “slices” to be made on a log entering the lumbermill, each laser indicator independently movable along with the multiple and corresponding saw blade producing the cut to the raw lumber material to be cut into planks.

In the Questions and Answer Section, titled “Laser Guides for Miter Saws”; American Woodworker: 2001 Buyer's Guide; Page 26, the article discusses the most recent products on the market are discussed, including those incorporating the technology disclosed in the previous patents, indicative that the best accuracy for these devices insures no more than a 1/32 inch accuracy.

### II. SUMMARY OF THE INVENTION

The primary objective of this invention is to provide a more precise cutting guide with micro-adjustment means which attaches to a fixed member of a stationary saw, as opposed to a moveable portion of the stationary saw. This device is not intended for use on hand-held rotary saws. In furtherance of this objective, the device includes a vertical frame member having a base clamp which attaches to the adjustable floor or the stationary base portion of a miter or chop saw. A proximal end of a horizontal frame member extends from the vertical frame member, wherein a locking ball joint attaches a mounting plate, pivotally attached to a laser guide by a locking pivot pin, to a distal end of the horizontal frame member. The balljoint is movable in a near 360 degree 3-dimensional plane, and the pivot pin allows further rotation in a 360 degree 2-dimensional plane. Further included on the mounting plate is a micro-adjustment means to allow for micro-adjustment of the laser guide. The laser guide emits a fixed and determined light guide on the surface to be cut ideally in a dimension of the standard ⅛th inch width of a saw blade, although the width of the beam may be adjusted to accommodate any size blade suitable for use on the saw, and 1-1½ inch length. A separate and additional mounting bracket is included for application of the device to a stationary portion of a radial arm saw.

### III. DESCRIPTION OF THE DRAWINGS

The following drawings are informal drawings submitted with this provisional patent application.

FIG. 1 is a rear view of the invention.

FIG. 2 is a side view of the invention.

FIG. 3 is a closer view of the side of the laser guide at the distal end of the horizontal frame member.

FIG. 4 is a closer view of the rear of the laser guide at the distal end of the horizontal frame member.

FIG. 5 is the accessory mounting bracket.

### IV. DESCRIPTION OF THE PREFERRED EMBODIMENT

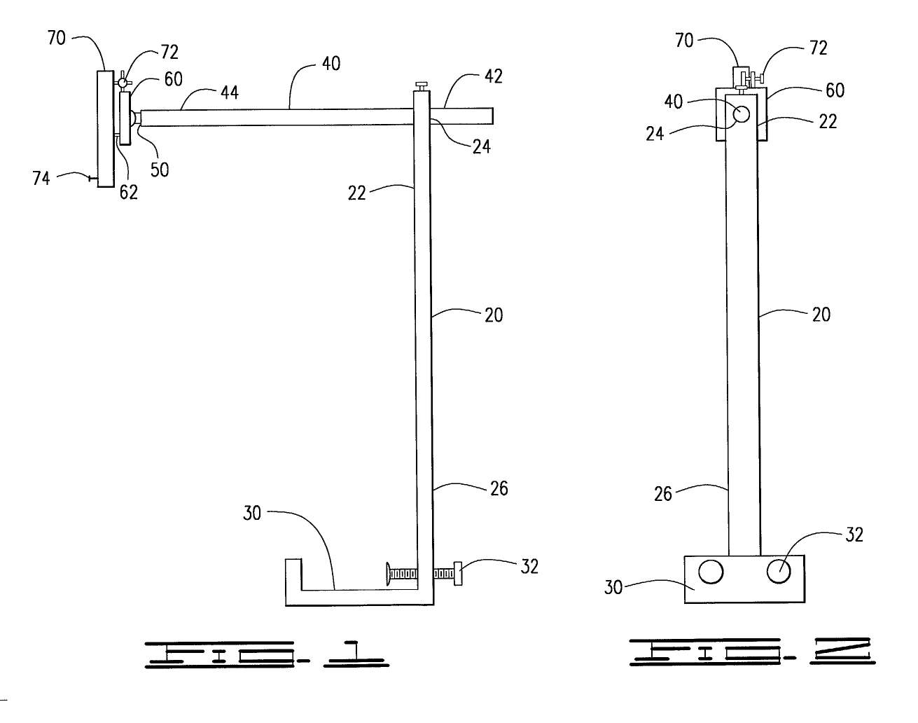

The invention, as shown in FIGS. 1-5 of the drawings, is a precision laser cutting guide to be attached to a stationary power saw, removably connected to a base portion of the power saw, as opposed to a retractable saw blade portion of the power saw, illuminating a location on the material to be cut with a confined and direct beam of light, the device 10 essentially comprising a vertical frame member 20 having a base clamp 30, a horizontal frame member 40 perpendicularly connected to the vertical frame member 20, a mounting plate 60 connecting to the horizontal frame member 40 by a locking ball joint 50, and a laser guide 70 pivotally attached to the mounting plate 60 having a micro-adjustment means 72 for precision setting of the laser guide 70 at a fixed and precise point on the material to be cut by the power saw indicative of the strike point of the saw blade.

The vertical frame member 20, as shown in FIGS. 1-2, has an upper end 22 and a lower end 26, the lower end 26 incorporating the base clamp 30. The base clamp 30 is provided with at least one screw clamping element 32. At the upper end 22 of the vertical frame member 20 is a horizontal frame member 40 attachment wherein the horizontal frame member 40 is perpendicularly and removably affixed to the vertical frame member 20. The base clamp 30 removably attaches the device to the base portion of the power saw.

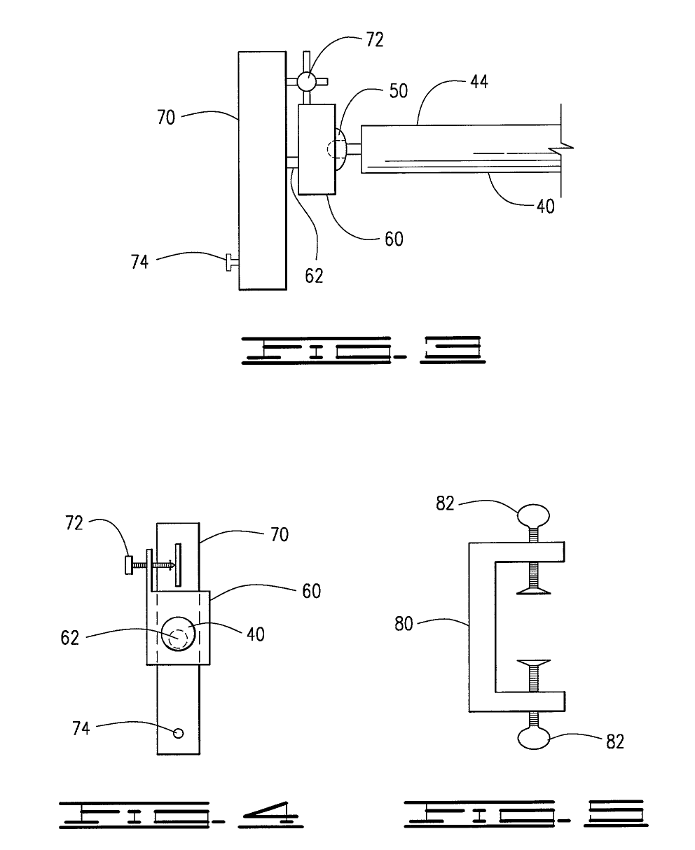

The horizontal frame member 40 has a proximal end 42, which is attached to the vertical frame member 20, and a distal end 44. The mounting plate 60, as shown in FIGS. 3-4 of the drawings, is attached to this distal end 44 of the horizontal frame member 40 by the locking balljoint 50, having the capacity to move in a near 360 degree three-dimensional plane. A pivot pin 62 pivotally attaches the laser guide 70 to the mounting plate 60, allowing for planar rotation of the laser guide 70 of 360 degrees. Also integrated between the mounting plate 60 and the laser guide 70 is the micro-adjustment means 72, allowing for the final precision placement of the light beam emitted by the laser guide 70 on the material to be cut at the precise location of the initial strike point of the rotating saw blade on the material to be cut.

In a preferred embodiment, the laser guide 70 emits a fixed and determined light mark on the surface to be cut in a dimension of ⅛th inch width, the width of a standard saw blade, and 1-1½ inch length. A width adjustment means 74 for adjusting the width of the laser beam may also be provided to allow for the adjustment of the laser beam to any saw blade width suitable for use on the saw to which the device is applied. In addition to the above noted components, the device may also include an accessory mounting bracket 80, having at least one screw clamping element 82, as shown in FIG. 5 of the drawings, for attaching the device to alternatively oriented stationary elements on the stationary saw. Although the embodiments of the invention have been described and shown above, it will be appreciated by those skilled in the art that numerous modifications may be made therein without departing from the scope of the invention as herein described.

I claim:

1. A precision laser cutting guide to be attached to a stationary power saw, removably connected to a base portion of the power saw, as opposed to a retractable saw blade portion of the power saw, illuminating a location on the material to be cut with a confined and direct beam of light, the device essentially comprising:
a. a vertical frame member having a base clamp;
b. a horizontal frame member relatively perpendicularly connected to the vertical frame member;
c. a mounting plate connecting to the horizontal frame member by a locking ball joint; and
d. a laser guide pivotally attached to the mounting plate having a micro-adjustment means for precision setting of the laser guide at a fixed and precise point on the material to be cut by the power saw indicative of the strike point of the saw blade.

2. A precision laser cutting guide to be attached to a stationary power saw, removably connected to a base portion of the power saw, as opposed to a retractable saw blade portion of the power saw, illuminating a location on material to be cut with a confined and direct beam of light, the device comprising:
a. a vertical frame member having an upper end and a lower end, the lower end incorporating a base clamp, the base clamp provided with at least one screw clamping element, removably attaching the vertical frame member to the base portion of the power saw.;
b. a horizontal frame member perpendicularly and removably affixed to the upper end of the vertical frame member, such horizontal frame member having a proximal end, attaching to the vertical frame member, and a distal end;
c. a mounting plate, attached to this distal end of the horizontal frame member by a locking ball joint having the capacity to move in a near 360 degree three-dimensional plane;
d. a pivot pin pivotally attaching a laser guide to the mounting plate, allowing for planar rotation of the laser guide of 360 degrees; and
e. a micro-adjustment means integrated between the mounting plate and the laser guide allowing for the final precision placement of a light beam emitted by the laser guide on a material to be cut at the precise location of an initial strike point of a rotating saw blade on the material to be cut.

3. The device, as disclosed in claim 2, wherein the laser guide emits a fixed and determined light mark on the surface to be cut in a dimension of ⅛th inch width, the width of a standard saw blade, and 1-1½ inch length, but also having width adjustment means for adjusting the width of the laser beam to allow for the adjustment of the laser beam to any saw blade width suitable for use on the saw to which the device is applied.

4. The device as disclosed in claim 2, wherein the device further comprises an accessory mounting bracket having at least one screw clamping element for attaching the device to alternatively oriented stationary elements on the stationary saw.
